(19) United States
(12) Patent Application Publication
(10) Pub. No.: US 2025/0260354 A1
(43) Pub. Date: Aug. 14, 2025

(54) MOTOR CONTROL DEVICE AND MOTOR CONTROL METHOD

(71) Applicant: TOYOTA JIDOSHA KABUSHIKI KAISHA, Toyota-shi (JP)

(72) Inventors: Junya HASEBE, Sunto-gun (JP); Hirokazu ITO, Sunto-gun (JP)

(73) Assignee: TOYOTA JIDOSHA KABUSHIKI KAISHA, Toyota-shi (JP)

(21) Appl. No.: 18/937,017

(22) Filed: Nov. 5, 2024

(30) Foreign Application Priority Data
Feb. 13, 2024 (JP) 2024-019506

(51) Int. Cl. H02P 29/62

(52) U.S. Cl. CPC H02P 29/62

(57) ABSTRACT

The transition mode includes: setting the target amplitude and the target lead angle, which are finally set in the heat creation mode according to the requested torque, to the target amplitude and the target lead angle at the start of the transition period; setting the target amplitude and the target lead angle, which are set in the normal mode according to the requested torque, to the target amplitude and the target lead angle at the end of the transition period; interpolating at least one target lead angle between the target lead angle at the start and the target lead angle at the end, and setting the interpolated target lead angle to the target lead angle in the transition period; and setting, for each target lead angle set in the transition period, the target amplitude so as to meet the requested torque.

### CROSS-REFERENCE TO RELATED APPLICATION

This application claims priority to Japanese Patent Application No. 2024-019506 filed on Feb. 13, 2024, incorporated herein by reference in its entirety.

### BACKGROUND

### 1. Technical Field

The technique disclosed in the present specification relates to devices and methods for controlling power supply from an inverter to a motor.

### 2. Description of Related Art

In a configuration in which power supply from an inverter to a motor is controlled to drive the motor, there are cases where the control mode is switched as necessary to create heat by the motor.

Japanese Unexamined Patent Application Publication No. 2017-189051 (JP 2017-189051 A) discloses a motor control device that switches a mode from a normal mode to a heating mode when the temperature of cooling oil in a motor housing is equal to or less than a predetermined value. According to JP 2017-189051 A, the heating mode is a mode in which the cooling oil is heated by heat generated by the resistance of a coil provided in a stator of a motor. This is a mode in which the motor is controlled with a current amplitude and a current phase that are different from those in a normal mode in which the motor is controlled with such a current amplitude and a current phase that the motor most efficiently outputs requested torque.

### SUMMARY

When performing such mode switching, a phenomenon is observed that the torque temporarily fluctuates significantly while changing the amplitude of the current to be output to the motor during transition from one mode to the other. The present specification provides an improvement measure for reducing such torque fluctuations (hereinafter, torque steps).

The present specification discloses a motor control device. The motor control device includes:
an inverter that supplies electric power to a motor; and
a control unit that sets a target amplitude and a target lead angle of a current to be applied to the motor according to requested torque and controls power supply from the inverter by feedback control.
   The control unit is configured to execute a normal mode, a heat creation mode, and a transition mode as a process of setting the target amplitude and the target lead angle. The heat creation mode is a mode in which the target amplitude is set to a larger value than in the normal mode according to the requested torque. The transition mode is a mode for a transition period from the heat creation mode to the normal mode.
   The transition mode includes
a first process of setting the target amplitude and the target lead angle that are set at an end of the heat creation mode according to the requested torque to the target amplitude and the target lead angle at a start of the transition period,
a second process of setting the target amplitude and the target lead angle that are set in the normal mode according to the requested torque to the target amplitude and the target lead angle at an end of the transition period,
a third process of interpolating at least one target lead angle between the target lead angle at the start and the target lead angle at the end, and setting the interpolated target lead angle to the target lead angle for the transition period, and
a fourth process of setting, for each of the target lead angles set for the transition period, the target amplitude so as to meet the requested torque.

With the above configuration, in the transition mode that is executed by the control unit, the control unit sets the target lead angle interpolated between the target lead angle at the start and the target lead angle at the end to the target lead angle for the transition period. The control unit then sets, for each of the target lead angles set for the transition period, the target amplitude so as to meet the requested torque. This configuration can reduce torque steps than in related art.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a configuration including a motor control device;

FIG. 2 is a flowchart illustrating a process performed by the first control unit in the transition mode;

FIG. 3A shows a torque-lead angle characteristic map;

FIG. 3B shows a torque-lead angle characteristic map;

FIG. 4 illustrates the control of this embodiment with respect to the transition period;

FIG. 5 is a flow chart showing a process according to a modification in which the first control unit executes in the transition mode; and

FIG. 6 illustrates conventional control over the transition period.

### DETAILED DESCRIPTION OF EMBODIMENTS

Embodiments will be described with reference to the drawings. Each of the drawings is merely an example, and the present embodiment is not limited to the illustrated contents. In addition, since each of the drawings is an example, the illustrated shape is not accurate or a part thereof is omitted.

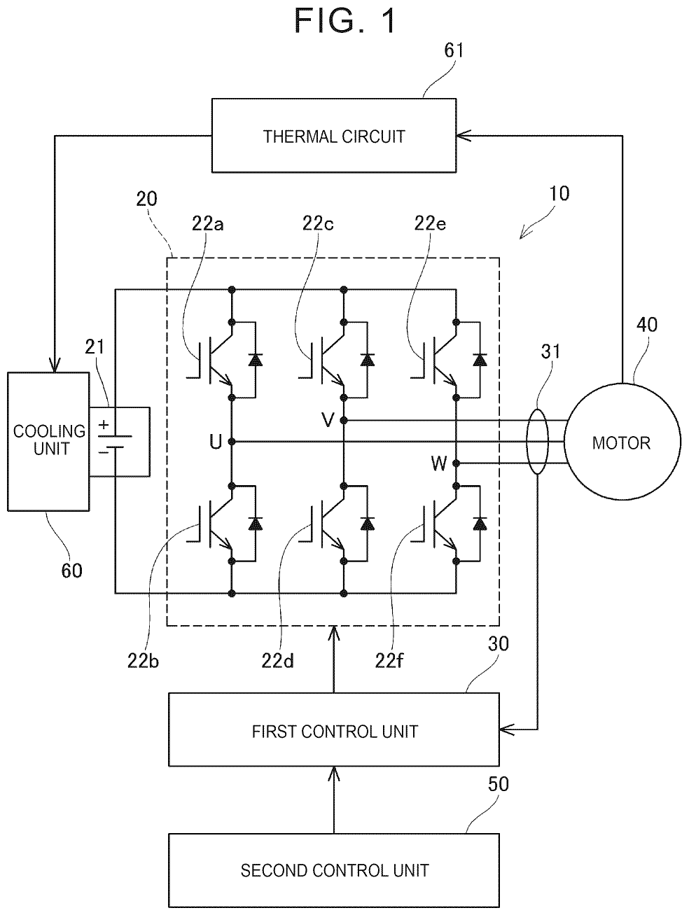

FIG. 1 schematically illustrates a configuration including a motor control device 10. The motor control device 10 generally includes an inverter 20 that supplies electric power to the motor 40, and a control unit 30 that performs FB control of supplying electric power by the inverter 20. In order to distinguish between the control unit 30 and a control unit 50 to be described later, the first control unit 30 and the second control unit 50 are referred to respectively. The battery 21 is a DC power supply, and the inverter 20 converts the DC supplied from the battery 21 into an AC and supplies the AC to the motor 40. The configuration illustrated in FIG. 1 can be mounted on vehicles such as a battery electric vehicle and a hybrid electric vehicle that travel by using the motor 40 as at least a part of a power source. The entire configuration shown in FIG. 1 may be regarded as the motor control device 10.

According to the exemplary embodiment of FIG. 1, the inverter 20 includes a plurality of switching elements 22a, 22b, 22c, 22d, 22e, 22f provided between the battery 21 and the motor 40, and constitutes a so-called three-phase (U-phase, V-phase, and W-phase) inverter. Hereinafter, the switching elements 22a to 22f are not distinguished from each other, and each switching element is simply referred to as a switching element 22. The circuit configuration of the inverter 20 is not particularly limited. The inverter 20 may include at least one switching element 22 for controlling power supply to the motor 40.

In the switching element 22a to 22f, the first switching element 22a and the second switching element 22b are connected in series, and constitute one leg (that is, a pair of upper and lower arms) of the three-phase inverter. The first switching element 22a is disposed on the upper arm, and the second switching element 22b is disposed on the lower arm. Similarly, among the switching elements 22a to 22f, the third switching element 22c and the fourth switching element 22d are connected in series, and constitute another leg of the three-phase inverter. The third switching element 22c is disposed on the upper arm, and the fourth switching element 22d is disposed on the lower arm.

Similarly, among the switching elements 22a to 22f, the fifth switching element 22e and the sixth switching element 22f are connected in series, and constitute another leg of the three-phase inverter. The fifth switching element 22e is disposed on the upper arm, and the sixth switching element 22f is disposed on the lower arm. The switching element 22 is not particularly limited, but may be, for example, MOSFET (Metal-Oxide-Semiconductor Field-Effect Transistor) or IGBT (Insulated Gate Bipolar Transistor). Further, a freewheeling diode is connected in anti-parallel to each of the switching elements 22.

The connection points of the switching elements 22 of the upper and lower arms of the respective phases are respectively connected to the coils of the corresponding phases of the motor 40. The inverter 20 supplies the three-phase AC power to the motor 40 by selectively and intermittently turning on and off the switching elements 22a to 22f under the control of the first control unit 30. The first control unit 30 includes a plurality of drive IC and processors for driving the respective switching elements 22a to 22f. Each of the first control unit 30 and the second control unit 50 may be regarded as a configuration including ECU (Electronic Control Unit).

The current flowing in each phase of the motor 40 is detected by the current sensor 31. The first control unit 30 receives information of the requested torque instructed from the second control unit 50, which is a higher-order controller, and controls the inverter 20 so that the torque of the motor 40 becomes the requested torque. In this case, the first control unit 30 sets the target amplitude and the target lead angle of the current to be applied to the motor 40 according to the requested torque. The first control unit 30 FB controls the power supplied by the inverter 20 so that a difference between the target amplitude of the current, that is, the target current value, and the current detected value based on the output of the current sensor 31 becomes small. The first control unit 30 adjusts the magnitude and the lead angle of the current flowing through the motor 40 by individually outputting drive signals to the switching elements 22a to 22f. The drive signal is, for example, a pulse-width modulated (PWM: Pulse Width Modulation) signal.

In addition, the motor 40 switches to the generator mode in response to accelerator-off and deceleration of the vehicle, and generates an AC voltage by kinetic energy of the wheels. The AC voltage generated by the motor 40 is converted into a DC voltage by the inverter 20 to charge the battery 21. Therefore, the motor 40 can be regarded as a motor generator.

The processing executed by the first control unit 30 corresponds to a “control step” in the claims. The first control unit 30 can execute a “normal mode” as a process of setting the target amplitude and the target lead angle, and a “heat creation mode” of setting the target amplitude to a larger value with respect to the requested torque than in the normal mode. The normal mode is, for example, a mode in which the motor 40 is controlled by the current magnitude and the current lead angle to realize the requested torque most efficiently, and is also referred to as a MTPA (Maximum Torque Per Ampere) mode. On the other hand, the heat creation mode is inefficient compared with the normal mode, and creates heat by the resistance of the coil by causing an unnecessarily large current to flow to the motor 40.

The battery 21 has a temperature suitable for charging, and the charging efficiency of the battery 21 decreases under a condition where the temperature of the battery 21 is lower than a predetermined temperature. Therefore, at least part of the heat generated in the motor 40 in the heat creation mode is used for heating the battery 21. Although shown very simply in FIG. 1, the cooling unit 60 is in contact with the battery 21. A cooling medium such as coolant circulates in the cooling unit 60, and the cooling unit 60 can cool the battery 21. Further, a heat circuit 61 is interposed between the motor 40 and the cooling unit 60, and in the heat creation mode, heat generated by the motor 40 is dissipated to the cooling medium of the cooling unit 60 through the heat circuit 61 to heat the cooling medium. Accordingly, in the heat creation mode, the temperature of the battery 21 is increased, and the charging efficiency of the battery 21 is prevented from decreasing.

During traveling of the vehicle, the switching between the heat creation mode and the normal mode is determined by the second control unit 50 based on, for example, the air temperature or the temperature of the battery 21. Therefore, the second control unit 50 instructs the first control unit 30 which one of the heat creation mode and the normal mode should be selected. In addition, since a transition period is required between the heat creation mode and the normal mode, the first control unit 30 can also execute a “transition mode” for the transition period from the heat creation mode to the normal mode as a process of setting the target amplitude and the target lead angle.

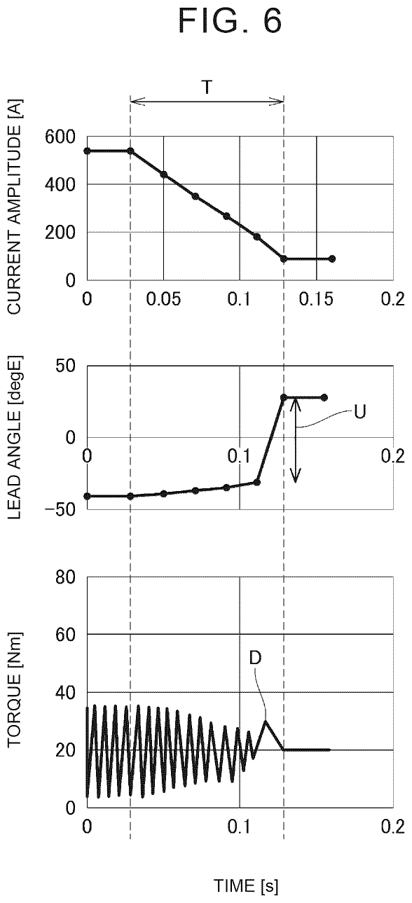

FIG. 6 is a diagram for explaining the conventional control related to the transition period, and shows the amplitude of the current flowing through the motor 40, the lead angle, and the torque generated in the motor 40, respectively, in a graph. The current amplitude may be interpreted as a peak-to-zero value. Further, the lead angle is an adjustment value of the current phase. Conventionally, in the transition period T until the normal mode is started after completion of the heat creation mode, as shown in the upper part of FIG. 6, the target amplitude is linearly decreased at every constant control interval (for example, 20 ms) from the current amplitude set according to the requested torque in the heat creation mode toward the current amplitude to be set according to the requested torque in the normal mode. When the target amplitude is changed at a constant change rate as described above, the change U of the lead angle with respect to the current change increases at the end of the transition period T, that is, in a state close to the normal mode (see the middle stage in FIG. 6). As a result, a torque step D in which the torque changes in a spike-like manner occurs at the end of the transition period T (see the lower stage in FIG. 6).

In the present embodiment, in order to suppress the occurrence of such a torque step D, the first control unit 30 performs the following processing in the transition mode.

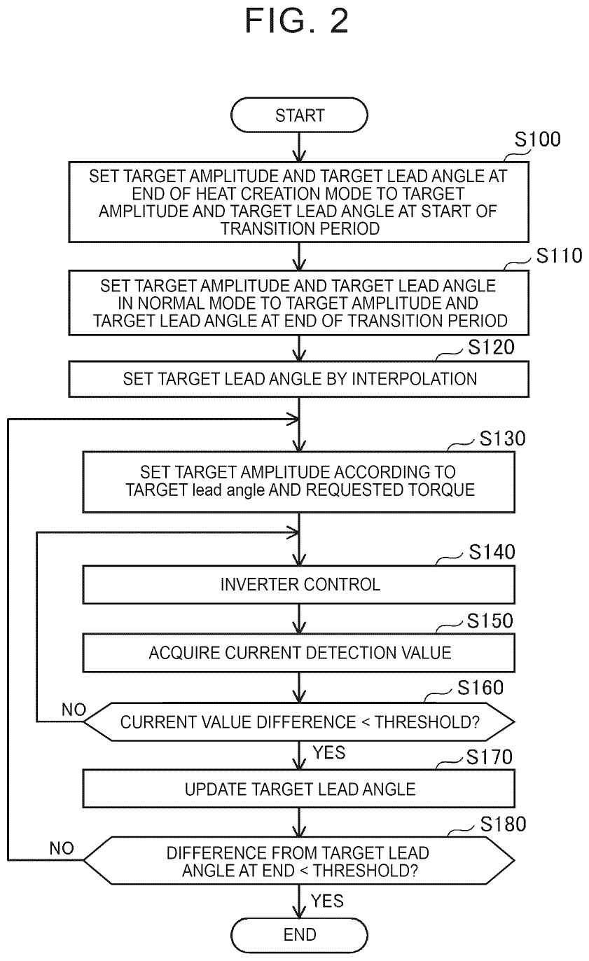

FIG. 2 is a flowchart illustrating a process performed by the first control unit 30 in the transition mode. The first control unit 30 starts the flowchart of FIG. 2 when a transition instruction from the heat creation mode to the normal mode is received from the second control unit 50.

In S100, the first control unit 30 sets the target amplitude and the target lead angle of the current set at the end of the heat creation mode according to the requested torque in the heat creation mode to the target amplitude and the target lead angle at the start of the transition period in the heat creation mode. S100 corresponds to the “first process”. In S110, the first control unit 30 sets the target amplitude and the target lead angle of the current set in the normal mode according to the requested torque to the target amplitude and the target lead angle at the end of the transition period. S110 corresponds to the “second process”.

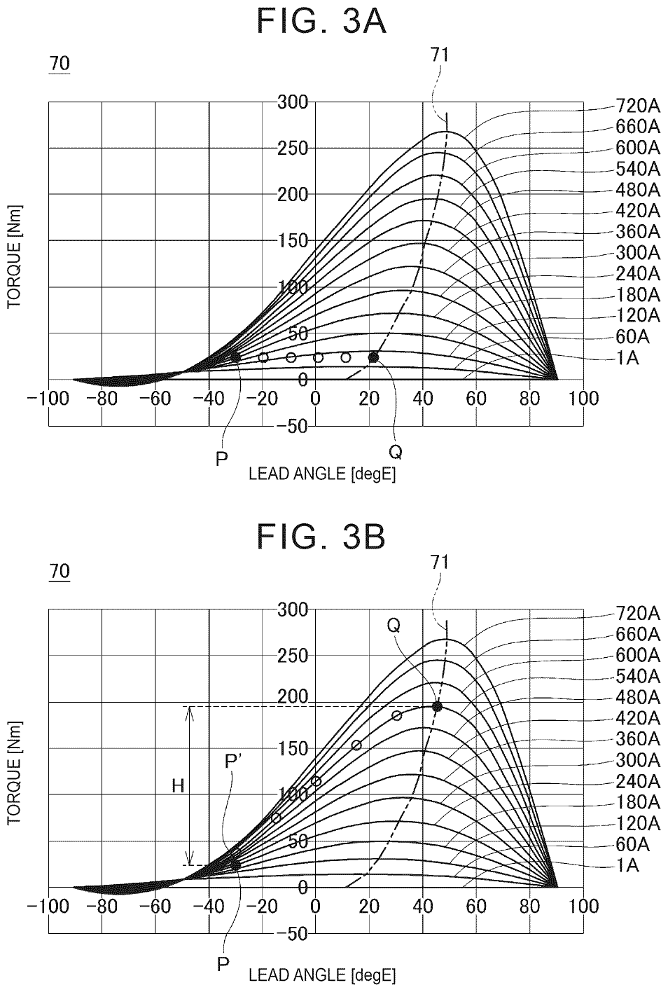

FIG. 3A shows a torque-lead angle characteristic map 70. The first control unit 30 holds the torque-lead angle characteristic map 70 in advance. The torque-lead angle characteristic map 70 defines the relationship between the lead angle and the torque for each current amplitude. In addition, a MTPA line 71 indicated by a long dashed double-short dashed line in the torque-lead angle characteristic map 70 indicates the relation between the current magnitude and the lead angle employed in the normal mode. That is, the first control unit 30 can maximize the torque of the motor 40 with the current amplitude by adopting a certain current amplitude and lead angle that satisfy MTPA line 71.

The heat creation control point P shown in the torque-lead angle characteristic map 70 is an example of the current amplitude and the lead angle set according to the requested torque in the heat creation mode. Further, the normal control point Q shown in FIG. 3A indicates a point on MTPA line 71 for realizing the same as or substantially the same as the heat creation control point P in the normal mode. During the period of the heat creation mode, the heat creation control point P may or may not change, but here it is assumed that the heat creation control point P is the target amplitude and the target lead angle of the current set at the end of the heat creation mode according to the requested torque. Therefore, in S100, the first control unit 30 sets the current amplitude and the lead angle of the heat creation control point P to the target amplitude and the target lead angle at the start of the transition period. Referring to FIG. 3A, in S110, the first control unit 30 sets the current amplitude and the lead angle of the normal control point Q to the target amplitude and the target lead angle at the end of the transition period.

In S120, the first control unit 30 interpolates N target lead angles between the target lead angle set by S100 and the target lead angle set by S110, and sets the target lead angle interpolated in this manner as the target lead angle in the transition period. S120 corresponds to the “third process”. N is an integer of 1 or more. For example, the first control unit 30 may determine the integer N based on the length of the predetermined transition period and the above-described control interval. Further, the first control unit 30 sets the target lead angle closest to the target lead angle set by S100 among the N target lead angles in the transition period to the present target lead angle in the transition period. In step 120, the first control unit 30 may interpolate the N target lead angles so that the range from the target lead angle set in S100 to the target lead angle set by S110 is divided at equal intervals. The intervals do not have to be exact equal intervals, but the N target lead angles in the transition period are set as close to equal intervals as possible.

In S130, the first control unit 30 sets the target amplitude by referring to the torque-lead angle characteristic map 70 based on the current target lead angle and the requested torque in the transition period. S130 corresponds to a “fourth process” in which the target amplitude is set for each target lead angle set for the transition period so as to meet that the requested torque. In the torque-lead angle characteristic map 70 of FIG. 3A, a plurality of open circles indicate a state in which the current value changes so that a constant torque is maintained according to the target lead angles obtained by equally dividing the value range of the lead angle between the heat creation control point P and the normal control point Q. In S130, such a current is set as a target amplitude corresponding to the present target lead angle.

In S140, the first control unit 30 controls the power supplied by the inverter 20 based on the set target lead angle and the set target amplitude. That is, the inverter 20 is controlled so that the lead angle and the amplitude of the current output from the inverter 20 to the motor 40 become the target lead angle and the target amplitude. In S150, the first control unit 30 acquires a current detection value based on the output of the current sensor 31.

In S160, the first control unit 30 compares a current value difference, which is a difference between the current target amplitude and the current detected value (amplitude), with a predetermined threshold value, and determines whether or not the current value difference is smaller than the threshold value. When the current difference is equal to or larger than the threshold, the first control unit 30 returns from the determination of “No” of S160 to S140, and repeats S140, S150. The cycling of S140-S160 corresponds to an exemplary FB control. When the current difference is smaller than the threshold, the first control unit 30 proceeds from the determination of “Yes” of S160 to S170.

In S170, the first control unit 30 updates the target lead angle. That is, the first control unit 30 sets, as the updated current target lead angle, the target lead angle close to the target lead angle (target lead angle at the start of the transition period) set in S100 next to the current target lead angle among the target lead angles (target lead angle at the end of the transition period) set in the N target lead angles and S110 described above. In S180, the first control unit 30 determines whether or not the difference between the current target lead angle updated by S170 and the target lead angle set by S110 is smaller than a predetermined threshold. Since the threshold value used in S180 is a threshold value for the lead angle difference, the threshold value for the current value difference used in S160 is naturally different.

When the difference between the updated target lead angle and the target lead angle set by S110 is equal to or larger than the threshold value, the first control unit 30 returns from the determination of “No” of S180 to S130 and repeats S130 and the subsequent steps. On the other hand, if the difference between the updated target lead angle and the target lead angle set by S110 is smaller than the threshold, the first control unit 30 determines “Yes” of S180 and ends the flow chart of FIG. 2. As a result, the transition mode ends and the normal mode starts. In S180, the first control unit 30 may determine whether or not the difference between the updated target lead angle and the target lead angle set by S110 is 0, and may terminate the flow chart from the determination of “Yes” if the difference is 0.

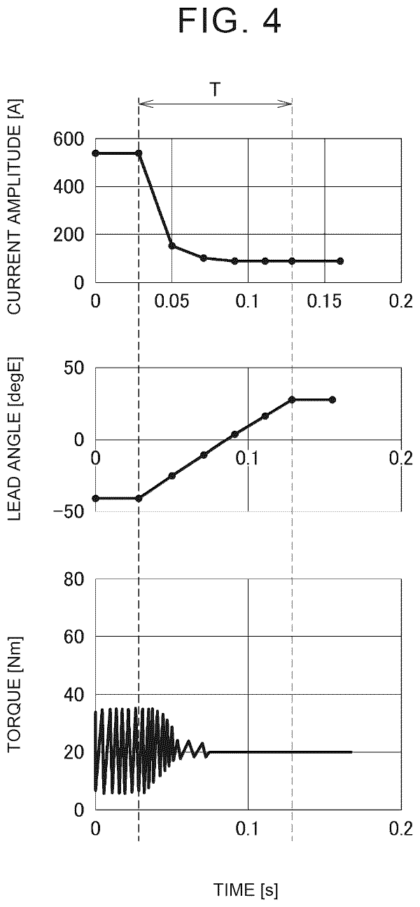

FIG. 4 is a diagram for explaining the control of the present embodiment with respect to the transition period, and shows the amplitude of the current flowing through the motor 40, the lead angle, and the torque generated in the motor 40, respectively, in a graph. The view of FIG. 4 is the same as the view of FIG. 6. According to the present embodiment, the first control unit 30 sets N target lead angles at equal intervals or substantially equal intervals in S120 with respect to the range between the target lead angle set by S100 and the target lead angle set by S110 as the target lead angle of the current in the transition period T (see the middle stage in FIG. 4). Then, the first control unit 30 sets the target amplitude of the current corresponding to the target lead angle set previously (S130). As a result, in the transition period T, the target amplitude changes nonlinearly with respect to time (see the upper part in FIG. 4), and in particular, the change in the target amplitude becomes gradual at the end of the transition period T. Since the change amount of the target lead angle is constant, the torque step D as shown in FIG. 6 does not occur at the end of the transition period T, and the torque is stabilized from the transition period T (transition mode) to the normal mode (see the lower stage in FIG. 4).

As described above, according to the present embodiment, the motor control device 10 includes the inverter 20 that supplies electric power to the motor 40 and the first control unit 30. The first control unit 30 sets a target amplitude and a target lead angle of the current to be applied to the motor 40 according to the requested torque, and FB controls the power supplied by the inverter 20. As the process of setting the target amplitude and the target lead angle, the first control unit 30 can execute a normal mode, a heat creation mode in which the target amplitude is set to a larger value with respect to the requested torque than in the normal mode, and a transition mode for a transition period from the heat creation mode to the normal mode. Transition modes include a first process, a second process, a third process and a fourth process. In the first process, the target amplitude and the target lead angle set at the end of the heat creation mode according to the requested torque are set to the target amplitude and the target lead angle at the start of the transition period. In the second process, the target amplitude and the target lead angle set in the normal mode according to the requested torque are set to the target amplitude and the target lead angle at the end of the transition period. In the third process, at least one target lead angle is interpolated between the target lead angle at the start of the transition period and the target lead angle at the end of the transition period, and the interpolated target lead angle is set as the target lead angle of the transition period. In the fourth process, the target amplitude is set or each target lead angle set for the transition period so as to meet the requested torque.

According to the above configuration, the first control unit 30 sets the target lead angle of the transition period by the third process, and then sets the target amplitude of the transition period corresponding to the target lead angle by the fourth process. As a result, it is possible to suppress the occurrence of the torque step D that has been conventionally observed at the end of the transition period.

Further, according to the present embodiment, in the third process, at least one target lead angle is interpolated so that the range from the target lead angle at the start of the transition period to the target lead angle at the end of the transition period is divided at equal intervals.

According to the above configuration, it is possible to more accurately suppress the occurrence of the torque step D by changing the target lead angle in the transition period at equal intervals.

The categories disclosed herein are not limited to devices, but also disclose methods. A motor control method for controlling the power supply to the motor 40 by the inverter 20 includes a control process for FB controlling the power supply by the inverter 20 by setting a target amplitude and a target lead angle of the current to be applied to the motor 40 according to the requested torque. In the control process, the normal mode, the heat creation mode, and the transition mode can be executed as the process of setting the target amplitude and the target lead angle. That is, such a motor control method can also achieve the above-described effects.

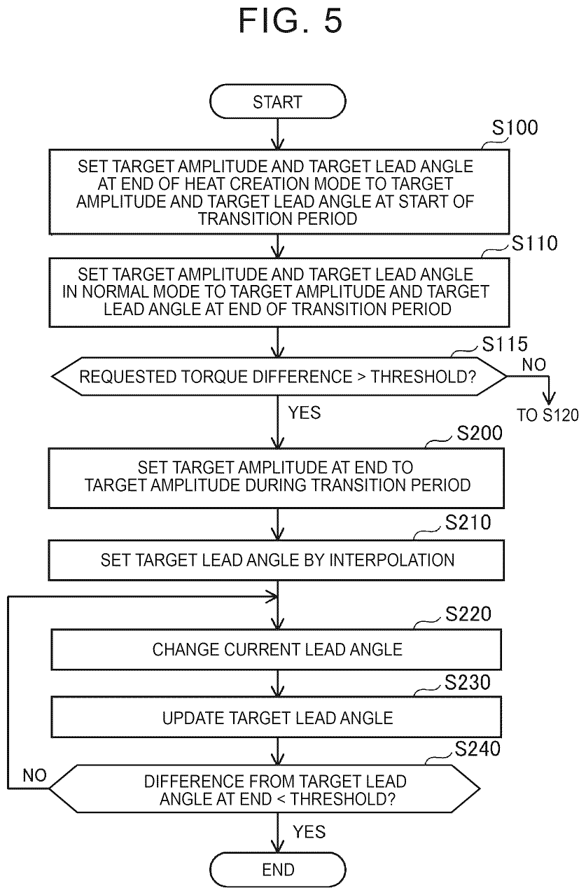

Next, a modification included in the present embodiment will be described referring to FIG. 3B and FIG. 5. According to a modification, the transition mode further includes a “fifth process” and a “sixth process” that are executed instead of the third process and the fourth process when the requested torque in the second process increases beyond a predetermined width with respect to the requested torque in the first process. The fifth process is a process of setting the target amplitude at the end of the transition period to the target amplitude during the transition period. The sixth process is a process of setting the target lead angle during the transition period by changing stepwise the target lead angle at the start of the transition period toward the target lead angle at the end of the transition period.

FIG. 5 is a flowchart illustrating a process according to the modification executed by the first control unit 30 in the transition mode. The description of FIG. 5 in common with FIG. 2 is basically omitted. S100, S110 is as described above. In S115, the first control unit 30 determines whether or not the “requested torque difference” exceeds a predetermined threshold for the torque difference. The requested torque difference is an increase range from the requested torque (first requested torque) in the first process to the requested torque (second requested torque) in the second process. The first requested torque is the requested torque when the target amplitude and the target lead angle are set at the end of the heat creation mode. The second requested torque is a requested torque when setting the target amplitude and the target lead angle in the normal mode. Simply, the difference between the requested torque (first requested torque) instructed by the second control unit 50 in the heat creation mode and the requested torque (second requested torque) instructed when the transition instruction from the heat creation mode to the normal mode is received from the second control unit 50 may be regarded as the requested torque difference.

The first control unit 30, when the requested torque difference exceeds the threshold value, proceeds from the determination of “Yes” of S115 to S200, whereas, when the requested torque difference is equal to or less than the threshold value, it proceeds from the determination of “No” of S115 to S120. The process of proceeding to S120 is as described above.

In S200, the first control unit 30 sets the target amplitude at the end of the transition period set by S110 to the target amplitude during the transition period. That is, in this modification, when the requested torque difference exceeds the threshold value, the first control unit 30 fixes the target amplitude during the transition period to the target amplitude at the end of the transition period, and FB controls the inverter 20. The target amplitude at the end of the transition period is, of course, the current amplitude that most efficiently generates the second requested torque corresponding to the target lead angle at the end of the transition period. S200 corresponds to the fifth process.

In S210, the first control unit 30 interpolates N target lead angles between the target lead angle set by S100 and the target lead angle set by S110, and sets the interpolated target lead angle as the target lead angle of the transition period. For S210, the explanation of S120 shall apply mutatis mutandis. In S220, the first control unit 30 controls the inverter 20 to change the current lead angle to the present target lead angle. In S230, the first control unit 30 updates the target lead angle.

In S240, the first control unit 30 determines whether or not the difference between the current target lead angle updated by S230 and the target lead angle set by S110 is smaller than a predetermined threshold for the lead angle difference. For S230, S240, the explanation of S170, S180 shall apply mutatis mutandis. When the difference between the updated target lead angle and the target lead angle set by S110 is equal to or larger than the threshold value, the first control unit 30 returns from the determination of “No” of S240 to S220 and repeats S220 and the subsequent steps. On the other hand, if the difference between the updated target lead angle and the target lead angle set by S110 is smaller than the threshold, the first control unit 30 determines “Yes” of S240 and ends the flow chart of FIG. 5. As a result, the transition mode ends and the normal mode starts. S210 to S240 are an example of the sixth process. According to the sixth process, the target lead angle during the transition period can be said to change stepwise at a constant rate.

FIG. 3B shows a torque-lead angle characteristic map 70 for describing the variant. In FIG. 3B, the same explanation as in FIG. 3A is omitted. In this modification, the position of the normal control point Q differs from that in FIG. 3A. That is, the normal control point Q shown in FIG. 3B corresponds to the target amplitude and the target lead angle for realizing the second requested torque in the normal mode, and the target amplitude and the target lead angle of the normal control point Q are set by S110. According to FIG. 3B, a reference sign H indicates a second requested torque—a first requested torque=a requested torque differential. It is determined that the requested torque difference H in FIG. 3B exceeds the thresholds in S115.

According to the exemplary of FIG. 3B, the normal control point Q is located at the apex of the curve corresponding to 540 [A] in the torque-lead angle characteristic map 70. Therefore, according to the exemplary embodiment of FIG. 3B, the value 540 [A] is the target amplitude at the end of the transition period and is set to the target amplitude during the transition period in S200. In the exemplary of FIG. 3B, the control point P′ represented by a white circle indicates that the target amplitude is changed from the target amplitude of the heat creation control point P to the same target amplitude as the normal control point Q by S200 process. Further, in FIG. 3B, a plurality of white circles other than the control point P′, during the transition period, the target lead angle is updated at a constant width while the target amplitude is maintained, the torque of the motor 40 is changed from the first requested torque to the second requested torque with this.

The effects of such a modification will be described. When the difference in requested torque, which is the difference between the first requested torque and the second requested torque, is large, if the torque is to be shifted while changing both the current amplitude and the current lead angle in the transition period, the deviation between the target torque and the actual torque becomes large during the transition period. torque step is likely to occur. In contrast, in this modification, the first control unit 30 performs the fifth process and the sixth process when the requested torque difference is larger than the threshold value. That is, by setting the target amplitude at the end of the transition period to the target amplitude during the transition period and then changing the target lead angle stepwise, it is possible to smoothly transition from the heat creation mode to the normal mode by suppressing the occurrence of the torque step.

While specific examples of the technology disclosed herein have been described in detail above, these are merely illustrative and do not limit the scope of the claims. Various modifications and variations of the specific examples described above are included in the technology described in the claims. In addition, the technical elements described in the present specification or the drawings exhibit technical usefulness alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A motor control device comprising:
an inverter that supplies electric power to a motor; and
a control unit that sets a target amplitude and a target lead angle of a current to be applied to the motor according to requested torque and controls power supply from the inverter by feedback control, wherein:
the control unit is configured to execute a normal mode, a heat creation mode, and a transition mode as a process of setting the target amplitude and the target lead angle, the heat creation mode being a mode in which the target amplitude is set to a larger value than in the normal mode according to the requested torque, and the transition mode being a mode for a transition period from the heat creation mode to the normal mode; and
the transition mode includes
a first process of setting the target amplitude and the target lead angle that are set at an end of the heat creation mode according to the requested torque to the target amplitude and the target lead angle at a start of the transition period,
a second process of setting the target amplitude and the target lead angle that are set in the normal mode according to the requested torque to the target amplitude and the target lead angle at an end of the transition period,
a third process of interpolating at least one target lead angle between the target lead angle at the start and the target lead angle at the end, and setting the interpolated target lead angle to the target lead angle for the transition period, and
a fourth process of setting, for each of the target lead angles set for the transition period, the target amplitude so as to meet the requested torque.

2. The motor control device according to claim 1, wherein in the third process, the at least one target lead angle is interpolated in such a manner that a range from the target lead angle at the start to the target lead angle at the end is divided at equal intervals.

3. The motor control device according to claim 1, wherein:
the transition mode further includes a fifth process and a sixth process that are performed instead of the third process and the fourth process when the requested torque in the second process is larger than the requested torque in the first process by more than a predetermined amount;
the fifth process is a process of setting the target amplitude at the end to the target amplitude during the transition period; and
the sixth process is a process of setting the target lead angle during the transition period by changing stepwise the target lead angle at the start toward the target lead angle at the end.

4. The motor control device according to claim 3, wherein in the sixth process, the target lead angle during the transition period changes stepwise at a constant rate.

5. A motor control method of controlling power supply from an inverter to a motor, the motor control method comprising a control process of setting a target amplitude and a target lead angle of a current to be applied to the motor according to requested torque and controlling the power supply from the inverter by feedback control, wherein:
the control process is configured to execute a normal mode, a heat creation mode, and a transition mode as a process of setting the target amplitude and the target lead angle, the heat creation mode being a mode in which the target amplitude is set to a larger value than in the normal mode according to the requested torque, and the transition mode being a mode for a transition period from the heat creation mode to the normal mode; and
the transition mode includes
a first process of setting the target amplitude and the target lead angle that are set at an end of the heat creation mode according to the requested torque to the target amplitude and the target lead angle at a start of the transition period,
a second process of setting the target amplitude and the target lead angle that are set in the normal mode according to the requested torque to the target amplitude and the target lead angle at an end of the transition period,
a third process of interpolating at least one target lead angle between the target lead angle at the start and the target lead angle at the end, and setting the interpolated target lead angle to the target lead angle for the transition period, and
a fourth process of setting, for each of the target lead angles set for the transition period, the target amplitude so as to meet the requested torque.
